(19) United States
(12) Patent Application Publication
(10) Pub. No.: US 2004/0233601 A1
(43) Pub. Date: Nov. 25, 2004

(54) Method of supplying power to low supply voltage power consumers

(76) Inventor: Thomas Duerbaum, Langerwehe (DE)

Correspondence Address: Russell Gross, US Philip Corporation, Intellectual Property Department, P O Box 3001, Briarcliff Manor, NY, 10510, US

(21) Appl. No.: 10/491,374

(22) PCT Filed: Oct. 3, 2002
(86) PCT No.: PCT/IB02/04085

(30) Foreign Application Priority Data
Oct. 5, 2001 (DE) 101 49 278.2

(51) Int. Cl. H02H 3/20

(52) U.S. Cl. 361/90

(57) ABSTRACT

The invention relates to a method of regulating the power supply for two or more power consumers, wherein at least two of the power consumers are connected to a direct-voltage source (1) via at least a respective voltage regulator (2₁ₐ, 2_{1b}, 2₂, . . . 2ₙ) and wherein each voltage regulator (2₁ₐ, 2_{1b}, 2₂, . . . 2ₙ) is supplied with an input voltage (U_{in,a}, U_{in,1b}, U_{in,2}, . . . , U_{in,n}) by the direct-voltage source (1) and supplies one of the power consumers with a steady voltage (U_{out,1a}, U_{out,1b}, U_{out,2}, . . . U_{out,n}). In order to optimize the voltage supply and to avoid high power losses and heat losses, it is proposed that a) for each voltage regulator (2₁ₐ, 2_{1b}, 2₂, . . . 2ₙ) a control signal is generated that is dependent at least on the applied input voltage (U_{in,1a}, U_{in,1b}, U_{in,2}, . . . U_{in,n}) and on a specific reference value (V_{ref,1a}, V_{ref,1b}, V_{ref,2}, . . . , V_{ref,n}) for the voltage regulator (2₁ₐ, 2_{1b}, 2₂, . . . 2ₙ) and b) the input voltages (U_{in,1a}, U_{in,1b}, U_{in,2}, . . . U_{in,n}) are regulated by the direct-voltage source (1) as a function of at least one of the generated control signals.

The invention relates to a method of regulating the power supply for two or more power consumers, wherein at least two of the power consumers are connected to a direct-voltage source via at least a respective voltage regulator and wherein each voltage regulator is supplied with an input voltage by the direct-voltage source and each supplies one of the power consumers with a steady voltage.

In constructing logic circuit systems, low supply voltage digital devices, so-termed “low voltage logical devices”, such as, for example, μCs and DSPs, are routinely used. The power supply employs power packs that, inter alia, are intended to separate the logic circuit arrangement from the mains and take over the transformation of the mains voltage to a low voltage. Frequently, the devices and the power pack are disposed on separate printed circuit boards since the power pack can be disposed on single-layer printed circuit board, whereas the logic devices are mounted on a multilayer printed circuit board, the so-termed application printed circuit board.

Frequently, not only one, but a plurality of supply voltages are needed on an application printed circuit board. For example, the processor unit of a DSP operates at 1.8 V, whereas the other circuit elements have to be supplied with 3.3 V. A plurality of processors that each operate with different supply voltages may also be used on an application printed circuit board. Furthermore, the devices that require the same supply voltage are situated at various points on the printed circuit board and require a stabilized voltage in situ. In addition, there are also frequently analog devices that need a well-regulated supply voltage.

In a predisclosed circuit arrangement for performing a method of the type mentioned in the opening paragraph, the power pack provides the required secondary voltages that serve as input voltage sources for downstream local voltage regulators. In that case, one of the secondary voltages is used to regulate the power pack.

An important disadvantage of such a circuit arrangement is that the chosen secondary voltages have to be so high that all the downstream voltage regulators function perfectly well under all the possible load conditions. In this connection, the voltage regulator having the smallest voltage reserve may change as a function of load conditions and parasitic elements (such as, for example, line resistances). Furthermore, even at low power consumption of all the loads, the voltages remain at the same high level. This results in an overall excessive voltage reserve and, consequently, in excessive power losses that have to be dissipated as heat.

It is an object of the present invention to provide a method of the type mentioned in the opening paragraph in which the abovementioned power losses are minimized.

This object is achieved in the case of a method of the type mentioned in the opening paragraph in that

a) for each voltage regulator a control signal is generated that is dependent at least on the applied input voltage and on a specific reference value for the voltage regulator and

b) the input voltages are regulated by the direct-voltage source as a function of at least one of the generated control signals.

In the following, a direct-voltage source is understood as meaning any voltage source that is suitable for providing a direct voltage. It may be, for example, a power pack or a converter, and the direct-voltage source may itself be supplied with a direct voltage or an alternating voltage. At the same time, the direct-voltage source may have one or more direct-voltage outputs, it being possible for identical or mutually different direct voltages to be applied to the various voltage outputs and one or more power consumers to be supplied from a respective voltage output.

In the following, power consumers are understood as meaning an individual switching element or an individual logic device, but alternatively as an arrangement of a plurality of circuit elements and/or logic devices, for example on an application printed circuit board. These also include analog devices and assemblies.

In accordance with the invention, provision is made that the supply voltage is stabilized for at least two of the power consumers by at least a respective voltage regulator. Depending on the voltage provided by the direct-voltage source at the input of each voltage regulator and a respective reference value specific for the voltage regulator, a control signal is generated that is used to regulate the voltages provided by the direct-voltage source. If the input voltage at one of the voltage regulators is too low, the voltages provided by the direct-voltage source are boosted. If the input voltages are all sufficiently high, the voltages provided by the direct-voltage source can be reduced.

As a basis for generating the control signal, the difference is formed between an actual value describing the working point of the respective voltage regulator and a reference value. A regulator generates a separate control signal on this basis in accordance with its regulator characteristic. All the control signals generated for the various voltage regulators are then compared with one another and the control signal for regulating the output voltages of the direct-voltage source is chosen and used for the voltage regulation of the power pack assigned to the voltage regulator having the lowest voltage reserve.

On the basis of the voltage regulation of the direct-voltage source as a function of the input voltages applied to the voltage regulators, it is possible to minimize the reserve necessary for a particular operating mode of the circuit in terms of the level of the voltages provided by the direct-voltage source and, nevertheless, to ensure a steady supply voltage for the individual power consumers. In this way, unnecessary power losses can be avoided. Since less waste heat is consequently also produced, the requirements imposed on the design heat dissipation measures are lower. This also results in advantages with regard to the reliability of the individual device and circuit elements.

Independently thereof, a direct-voltage source regulated in this way can also supply power consumers that are not critical with regard to fluctuating input voltages. Such power consumers may be connected to the direct-voltage source directly (without inserting a voltage regulator).

Preferably, as a reference for at least one of the voltage regulators, a minimum setpoint value is used for the input voltage necessary for said voltage regulator and the control signal is determined from a function of the difference between the actual value of the locally applied input voltage and the minimum setpoint value of the input voltage. The minimum input voltage value is at the same time dependent on the type of voltage regulator and the level of the stabilizing output voltage.

In another preferred refinement of the method, as a reference value for at least one of the voltage regulators, a minimum setpoint value may also be used for the difference between input voltage and output voltage at said voltage regulator and the control signal can be determined from a function of the minimum setpoint value and the actual value of the difference that exists between the input voltage applied to said voltage regulator and the output voltage.

A preferred option for generating the control signal for one of the voltage regulators is to use an operational amplifier as an error amplifier to which the analog signals for the actual value of the working point of the voltage regulator and also the signal for the associated reference value are applied. The difference between the applied signals and a control signal that can be tapped from the output of the operational amplifier is amplified in accordance with the regulator characteristic.

Another preferred option for generating a control signal for one of the voltage regulators is to use a hysteresis regulator, in particular a Schmitt trigger, to which the analog signals for the actual value of the working point of the voltage regulator and also the signal for the associated reference value are applied. In the case of such a hysteresis regulator, the control signal is set high if a lower limit of the difference between actual signal for the working point of a voltage regulator and the associated reference value is reached and is set low again if an upper limit of said difference is reached. Consequently, the critical voltage for the respective voltage regulator can be monitored within a window.

An advantageous option for generating the control signal also consists of digitally determining the actual value for the working point of a voltage regulator by means of a A/D conversion and the control signal is generated from a function of the digitally converted input voltage and a digital reference value. A digital control signal can preferably be generated therefrom, but the control signal can also be converted again into an analog signal.

Preferably, it is precisely the control signal at which the actual value of its input voltage or the actual value of the difference between its output voltage and input voltage has reached the reference value or dropped below it that is chosen to regulate the direct-voltage source. For this purpose, all the control signals, provided they are analog, can preferably be compared by a diode network by means of which the control signal for the voltage regulator whose input voltage is critical is selected and is connected through to the power pack to regulate the output voltage of the power pack.

In principle, it is also possible to evaluate the control signals digitally, in particular if the control signals are in any case digital, but also if the control signals are A/D-converted. It is precisely in the case of digital evaluation of the control signals that it is possible in a simple way to select the control signal for the voltage regulator at which the voltage reserve has been reached or dropped below.

In a preferred embodiment of the method, a power pack, in particular a primary switched-mode power supply unit is used as direct-voltage source. Suitable as switched-mode power supply units are, in particular, AC/DC converters and DC/DC converters whose power consumption can be regulated on the primary side of the converter. At the same time, the voltage at the outputs of the switched-mode power supply unit may also be regulated.

Linear voltage regulators and also switching regulators may preferably be used as voltage regulators.

The invention will be further described with reference to examples of embodiment shown in the drawings to which, however, the invention is not restricted. In the drawings:

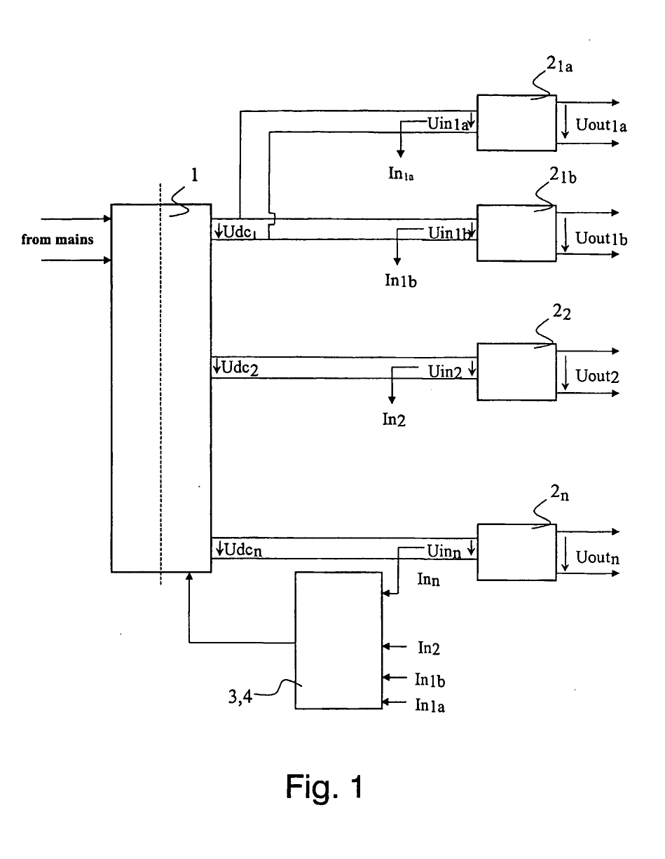

FIG. 1 shows a circuit diagram representing the principle of the invention, and

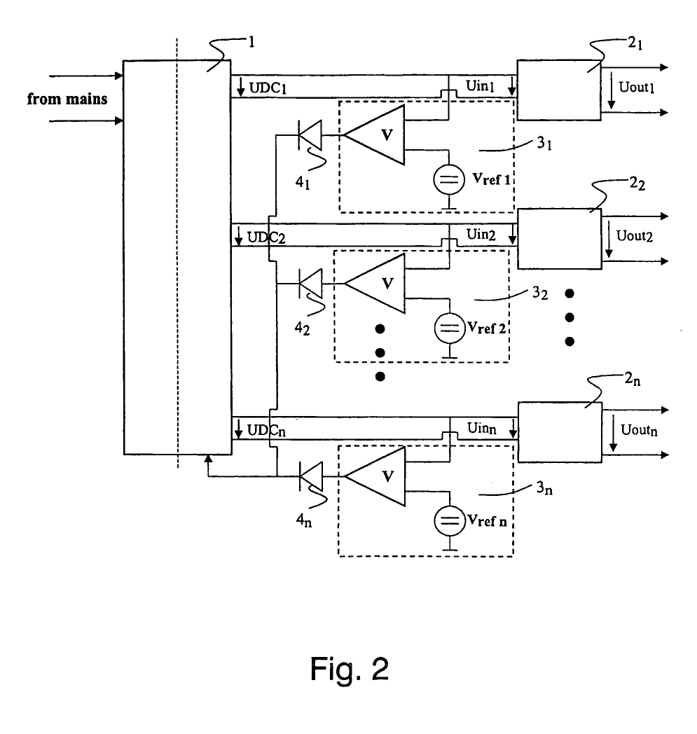

FIG. 2 shows a preferred circuit arrangement for performing the method according to the invention.

The circuit diagram shown in FIG. 1 shows a master power pack 1 as a voltage source whose input is connected to an alternating voltage mains and that has n different voltage outputs Udc₁, Udc₂, . . . , Udcₙ.

Each of the voltage outputs Udc₁, Udc₂, . . . , Udcₙ is connected to at least one input of a linear regulator 2₁ₐ, 2_{1b}, 2₂, . . . 2ₙ and supplies them with an input voltage U_{in,1a}, U_{in,1b}, U_{in,2}, . . . U_{in,n}. Each of the voltage regulators is connected to an power consumer, which is not shown here, and supplies it with a regulated output voltage U_{out,1a}, U_{out,1b}, U_{out,2}, . . . U_{out,n}.

An actual value In₁ₐ, In_{1b}, In₂, . . . , Inₙ for its working point is tapped from each of the voltage regulators 2₁ₐ, 2_{1b}, 2₂, . . . 2ₙ. Said actual value In₁ₐ, In_{1b}, In₂, . . . , Inₙ may, for example, be, as shown, the respective applied input voltage U_{in,1a}, U_{in,1b}, U_{in,2}, . . . U_{in,n} or, alternatively, a difference value between the input voltage U_{in,1a}, U_{in,1b}, U_{in,2}, . . . U_{in,n} and its output voltage U_{out,1a}, U_{out,1b}, U_{out,2}, . . . U_{out,n}.

In a driver circuit 3, 4 difference values are formed for each voltage regulator 2₁ₐ, 2_{1b}, 2₂, . . . 2ₙ between the actual value assigned to it In₁ₐ, In_{1b}, In₂, . . . , Inₙ and the necessary reference value V_{ref,1}, V_{ref,2}, . . . V_{ref,n} and a control signal is generated therefrom for each voltage regulator 2₁ₐ, 2_{1b}, 2₂, . . . 2ₙ . The reference value for the respective voltage regulator 2₁ₐ, 2_{1b}, 2₂, . . . 2ₙ may, for example, be a value for the necessary minimum input voltage or, alternatively, a minimum setpoint value for the difference between input voltage and output voltage of the respective voltage regulator 2₁ₐ, 2_{1b}, 2₂, . . . 2ₙ.

From the difference values, the critical value and, consequently, the voltage regulator 2₁ₐ, 2_{1b}, 2₂, . . . 2ₙ is determined at which the voltage reserve is lowest. The control signal generated for the critical value is then selected by the driver circuit 3, 4 and is connected through to the power pack 1 to regulate the output voltages of the power pack 1.

Depending on the design of the driver circuit 3, 4, the actual values In₁ₐ, In_{1b}, In₂, . . . , Inₙ for the working points of the voltage regulators 2₁ₐ, 2_{1b}, 2₂, . . . 2ₙ may be processed either in analog form or they may be converted digitally so that the evaluation of the working points of the voltage regulators 2₁ₐ, 2_{1b}, 2₂, . . . 2ₙ and also the generation of control signals can take place in digital form.

The analog circuit arrangement shown in FIG. 2 corresponds to the circuit diagram shown in FIG. 1, the driver circuit 3, 4 being designed in the present case as an analog circuit. For every voltage regulator 2₁, 2₂, . . . 2ₙ shown here as a linear regulator, the driver circuit has an error amplifier or operational amplifier 3₁, 3₂, . . . 3ₙ, to whose input the input voltage U_{in,1}, U_{in,2}, . . . , U_{in,n}, applied to the respective voltage regulator 2₁, 2₂, . . . 2ₙ and also an associated reference value V_{ref,1}, V_{ref,2}, . . . V_{ref,n} are applied. Disposed downstream of the output of every operational amplifier is a diode 4₁, 4₂, . . . 4ₙ, all the diodes being interconnected to form a diode network.

The operational amplifiers supply a positive output signal as control signal if the respective reference value is slightly exceeded. The diode network 4₁, 4₂, . . . 4ₙ switches through only the highest output signal as control signal for regulating the power pack 1. This ensures that the voltage reserve is always determined by the critical or most critical voltage regulator.

1. A method of regulating the power supply for two or more power consumers, wherein at least two of the power consumers are each connected to a direct-voltage source (1) via at least a respective voltage regulator (2₁ₐ, 2_{1b}, 2₂, . . . 2ₙ) and wherein each voltage regulator (2₁ₐ, 2_{1b}, 2₂, . . . 2ₙ) is supplied with an input voltage (U_{in,a}, U_{in,1b}, U_{in,2}, . . . , U_{in,n}) by the direct-voltage source (1) and each supplies one of the power consumers with a steady voltage (U_{out,1a}, U_{out,1b}, U_{out,2}, . . . U_{out,n}) characterized in that
a) for each voltage regulator (2₁ₐ, 2_{1b}, 2₂, . . . 2ₙ), a control signal is generated that is dependent at least on the applied input voltage (U_{in,1a}, U_{in,1b}, U_{in,2}, . . . U_{in,n}) and on a specific reference value (V_{ref,1a}, V_{ref,1b}, V_{ref,2}, . . . V_{ref,n}) for the voltage regulator (2₁ₐ, 2_{1b}, 2₂, . . . 2ₙ ) and
b) the input voltages (U_{in,1a}, U_{in,1b}, U_{in,2}, . . . U_{in,n}) are regulated by the direct-voltage source (1) as a function of at least one of the generated control signals.

2. A method as claimed in claim 1, characterized in that the reference value (V_{ref,1a}, V_{ref,1b}, V_{ref,2}, . . . , V_{ref,n}) for at least one of the voltage regulators (2₁ₐ, 2_{1b}, 2₂, . . . 2ₙ) is a minimum setpoint value for the input voltage necessary for said voltage regulator (2₁ₐ, 2_{1b}, 2₂, . . . 2ₙ) and the control signal is determined from a function (f(Uᵢₙ-V_{ref})) of the difference between the actual value of the applied input voltage (U_{in,1a}, U_{in,1b}, U_{in,2}, . . . U_{in,n}) and the minimum setpoint value of the input voltage.

3. A method as claimed in claim 1 characterized in that the reference value (V_{ref,1a}, V_{ref,1b}, V_{ref,2}, . . . , V_{ref,n}) for at least one of the voltage regulators (2₁ₐ, 2_{1b}, 2₂, . . . 2ₙ) is a minimum setpoint value for the difference between input voltage and output voltage at said voltage regulator (2₁ₐ, 2_{1b}, 2₂, . . . 2ₙ) and the control signal is determined from a function (f(Uᵢₙ-Uₒᵤₜ)-V_{ref})) of the minimum setpoint value and the actual value of the difference that exists between the input voltage (U_{in,1a}, U_{in,1b}, U_{in,2}, . . . U_{in,n}) applied to said voltage regulator (2₁ₐ, 2_{1b}, 2₂, . . . 2ₙ) and the output voltage (U_{out,1a}, U_{out,1b}, U_{out,2} , . . . U_{out,n}).

4. A control method as claimed in one of claims 1, characterized in that an error amplifier is used to generate the control signal for at least one of the voltage regulators (2₁ₐ, 2_{1b}, 2₂, . . . 2ₙ)

5. A regulating method as claimed in claim 1, characterized in that a hysteresis regulator, in particular a Schmitt trigger, is used to generate the control signal for at least one of the voltage regulators (2₁ₐ, 2_{1b}, 2₂, . . . 2ₙ).

6. A regulating method as claimed in one of claim 1, characterized in that the input voltage (U_{in,1a}, U_{in,1b}, U_{in,2}, . . . U_{in,n}) is determined digitally at at least one of the voltage regulators (2₁ₐ, 2_{1b}, 2₂, . . . 2ₙ) and the control signal is generated from a function (f(Uᵢₙ, V_{ref})) of the digitally converted input voltage (U_{in,1a}, U_{in,1b}, U_{in,2}, . . . U_{in,n}) and a digital reference value (V_{ref,1a}, V_{ref,1b}, V_{ref,2}, . . . V_{ref,n}).

7. A regulating method as claimed in claim 1, characterized in that precisely that control signal for the voltage regulator (2₁ₐ, 2_{1b}, 2₂, . . . 2ₙ) is selected for regulating the direct-voltage source (1) at which the actual value of its input voltage or the actual value of the difference between its output voltage and input voltage has reached the reference value (V_{ref,1a}, V_{ref,1b}, V_{ref,2}, . . . , V_{ref,n}) or dropped below it.

8. A regulating method as claimed in claim 1, characterized in that the control signal for regulating the direct-voltage source (1) is selected by a diode network.

9. A regulating method as claimed in claim 1, characterized in that the control signals are evaluated digitally.

10. A regulating method as claimed in claim 1, characterized in that a power pack, in particular a primary switched-mode power supply unit, is used as direct-voltage source (1).

11. A circuit arrangement having means for regulating the power supply for two or more power consumers, wherein at least two of the power consumers are connected to a direct-voltage source (1) via at least a respective voltage regulator (2₁ₐ, 2_{1b}, 2₂, . . . 2ₙ) and wherein an input voltage (U_{in,a}, U_{in,1b}, U_{in,2}, . . . , U_{in,n}) is assigned to each of the voltage regulators (2₁ₐ, 2_{1b}, 2₂, . . . 2ₙ) for supplying the power consumers with a steady voltage ((U_{out,1a}, U_{out,1b}, U_{out,2}, . . . U_{out,n}), characterized in that
a) for each voltage regulator (2₁ₐ, 2_{1b}, 2₂, . . . 2ₙ) the generation of a control signal is provided that is dependent at least on the applied input voltage (U_{in,1a}, U_{in,1b}, U_{in,2}, . . . U_{in,n}) and on a specific reference value (V_{ref,1a}, V_{ref,1b}, V_{ref,2}, . . . , V_{ref,n}) for the voltage regulator (2₁ₐ, 2_{1b}, 2₂, . . . 2ₙ) and
b) a regulation of the input voltages (Uin,1a, Uin,1b, Uin,2, . . . Uin,n) of the direct voltage source (1) is provided as a function of at least one of the generated control signals.
